(19) United States
(12) Patent Application Publication
(10) Pub. No.: US 2003/0195441 A1
(43) Pub. Date: Oct. 16, 2003

(54) Remotely controllable stimulator system and device

(76) Inventor: Parviz Firouzgar, Laguna Niguel, CA (US)

Correspondence Address: Michael W. Starkweather, Jones, Waldo, Holbrook & McDonough, Suite 1500, 170 South Main Street, Salt Lake City, UT, 84101, US

(21) Appl. No.: 10/123,265

(22) Filed: Apr. 16, 2002

(51) Int. Cl. A61H 23/02

(52) U.S. Cl. 601/46; 601/70

(57) ABSTRACT

A self-contained remotely controllable stimulator provides a gentle, sensual stimulation to users via a radio-controlled receiver that is similar to that used in electronic message pager systems. This stimulator is in one embodiment embedded into a wearable item that is soft with round corners and generally flat such as a feminine hygiene pad. In another embodiment the device is mounted as a locket or bracelet. When the stimulator is activated, an offset vibrator motor is turned on, creating a vibration effect against the wearer. The stimulator can be used to provide knowledge to the wearer that the one who activated the stimulator was sending a message with a special meaning.

### FIELD OF THE INVENTION

The present invention pertains to a stimulation devices and systems.

### BACKGROUND OF THE INVENTION

Marital or sensual aids have been known and used throughout the centuries. Generally, such aids have been designed either for self-stimulation or for the stimulation of one party only. However, such aids are typically utilized to achieve a certain level of sexual satisfaction.

Of these types of aids, those designed primarily for use by females have often incorporated a flexible phallic shape. Variations include two such phallic shapes secured to opposite sides of a common or intermediate flange. There are also multiple designs of clitoral, non-vaginal, vibrators.

It is also common for these devices to not be self-retaining. Instead, such devices rely upon a series of straps in order to hold and retain the device in place for proper use. However, fastening such straps prior to use is both cumbersome and discomforting and causes undesirable delay.

It is a generally accepted assumption that the use of such devices is to provide a sexual response.

It is one object of the invention to provide a sensual massage system capable for stimulating the erogenous areas of a wearer and the mental satisfaction to the actuating partner sending the message.

It is another object of the invention to provide a sensual massage system device that is self-retaining by a female in a disposable, adhesive, sanitary napkin-like package.

It is further an object of the invention to provide a device that is capable of being used by partners of the same or opposite sex.

It is yet another object of the invention to provide a stimulation messaging device that is wearable as jewelry item such as a necklace or bracelet.

### SUMMARY OF THE INVENTION

The foregoing and other objects are obtained in a system and wearable devices in accordance with the principles of the invention. In accordance with the principles of the invention, a self-contained remotely controllable stimulator provides a gentle, sensual stimulation via a wireless communication device that in the illustrative embodiments utilizes a radio control device. In accordance with one aspect of the invention, the radio control device includes a microprocessor.

The stimulation device can be used to provide sexual stimulation, but in accordance with another aspect of the invention can be used to provide knowledge to a wearer of the stimulator, activation that the one who remotely activated the stimulator was sending a message to a body area with special meaning, like the area of the heart or wrist.

In one embodiment in accordance with the principles of the invention, a stimulator is embedded in a wearable article. In that one embodiment of the invention, the stimulator may be provided with soft, flat, and round corners similar to a feminine hygiene pad. When the stimulator is activated, a stimulating vibration is provided against the clitoral area of the wearer.

In accordance with another aspect of the invention, the stimulator utilizes a miniature vibrator. The vibrator is controlled utilizing wireless communication devices.

A sensual massage system in accordance with the invention includes a wireless controlled vibrator selectively operable via a wireless system and wearable by a user; and a wireless system selectively operable to actuate said vibrator. The wireless system in an illustrative embodiment comprises a radio frequency paging system; and the wireless controlled vibrator includes a pager receiver. In accordance with one aspect of the invention the wireless system may be accessible via a telephone, personal digital assistant (PDA) or via the Internet using a computer or such other device.

In one embodiment of the invention, the vibrator is embeddable in a users clothing. The vibrator system is embedded in an enclosure that is adapted for retention proximate the clitoral region of a female wearer. In another embodiment of the invention, a jewelry item carries the vibrator, like a locket, necklace or braclet.

In accordance with the principles of the invention, the vibrator may comprise a pancake offset type vibrator. The vibrator may include a raised portion for stimulating the clitoral region of a user.

In accordance with yet another aspect of the invention, the vibrator is operable to provide predetermined vibration patterns. In an embodiment of the invention at least one of said patterns approximates a heartbeat or Morse code sending a message. The predetermined vibration patterns are determined in accordance with information provided via the wireless system. In another embodiment, intensity of the vibration can vary, i.e. slow to fast.

### BRIEF DESCRIPTION OF THE DRAWING

The invention will be better understood from a reading of the following detailed description of an illustrative embodiment of the invention in conjunction with the drawing figures in which like reference designations are used to identify like elements, and in which:

FIG. 1 is a top view of a device in accordance with the invention;

FIG. 2 is a cross-sectional view of a wireless controlled vibrator included in the device shown in FIG. 1;

FIG. 3 is a top view of a wearable item including the device of FIG. 1;

FIG. 4 is a top view of a jewelry item in accordance with the invention; and

FIG. 5 is a block diagram of a system in accordance with the principles of the invention.

### DETAILED DESCRIPTION

The present invention is a self-contained remote control stimulator that provides a gentle, sensual stimulation to external female genitals via a wireless device. The present invention utilizes wireless technology of a type that is utilized in pagers. Although various types of pager systems are known, the present invention makes advantageous use of vibrators of the type utilized in vibrating pagers. Pagers of a type that may be most advantageously utilized are of a type in which pager receiver utilizes radio frequency signals to receive a page. Such pagers each have a unique code or address and are therefore selectively addressable even though a large number of pagers may share a single paging frequency authorized by current FCC regulations. Certain pager receivers are responsive to group paging in addition to individual paging. Radio frequency (RF) signaling technologies are well known and any one of a number of RF technologies may be advantageously employed in the invention. In addition, other wireless technologies may be utilized such as infrared or ultrasound based wireless communication.

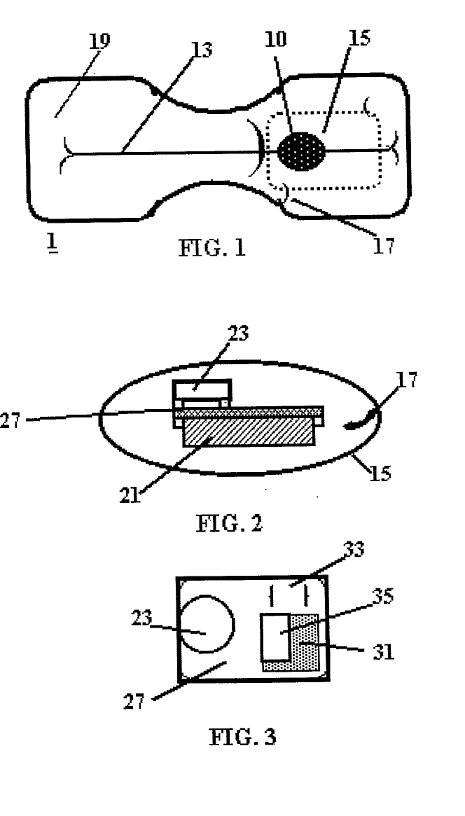

Turning now to FIG. 1, a stimulation device 1 in accordance with the principles of the invention is shown. The stimulation device 1 is wearable on the body and in one embodiment shown in FIG. 1 is embedded in a soft, generally flat shaped member 11 that is shaped similar to a feminine hygiene pad. Member 11 includes an insertion flap 13, and includes padding, which is not shown. The pad member 11 is typically disposable, and is used to place a stimulation device 15 proximate an area of the human body, typically the clitoral area of a woman. Stimulation device 15 is secured into a fixed position in member 11 by secure tabs 17. Member 11 may include an adhesive side 19 which may be used to secure member 11 into, for example, a woman's panties so that the stimulation device 1 may be worn in an inconspicuous manner. A slightly raised area 10 may be provided to enhance contact with specific body regions such as the clitoral region of the wearer.

Stimulation device 15 is shown in cross-sectional view in FIG.2, Stimulation device 15 includes a wireless receiver/vibrator assembly 21 in a sealed enclosure 23. Wireless receiver/vibrator 21 includes a vibrator that in the illustrative embodiment is an offset pancake motor vibrator 23 mounted onto a circuit board or carrier 25. Circuit board or carrier 25 in the illustrative embodiment is a printed circuit board 27. Printed circuit board 27 carries a battery 29. As more clearly seen in FIG. 3, printed circuit board 27 carries a receiver circuit 31. Circuit 31 is a wireless receiver circuit that has associated with it an antenna array 33. Circuit 27 includes a microprocessor 35 that is utilized to detect specific addresses and functionalities that are received via the wireless signals to control the vibrator 23. Antenna array 33 is tuned to be most effective at the radio frequency of interest. The antenna may include antenna loading to improve the efficiency of the receiver circuit 31.

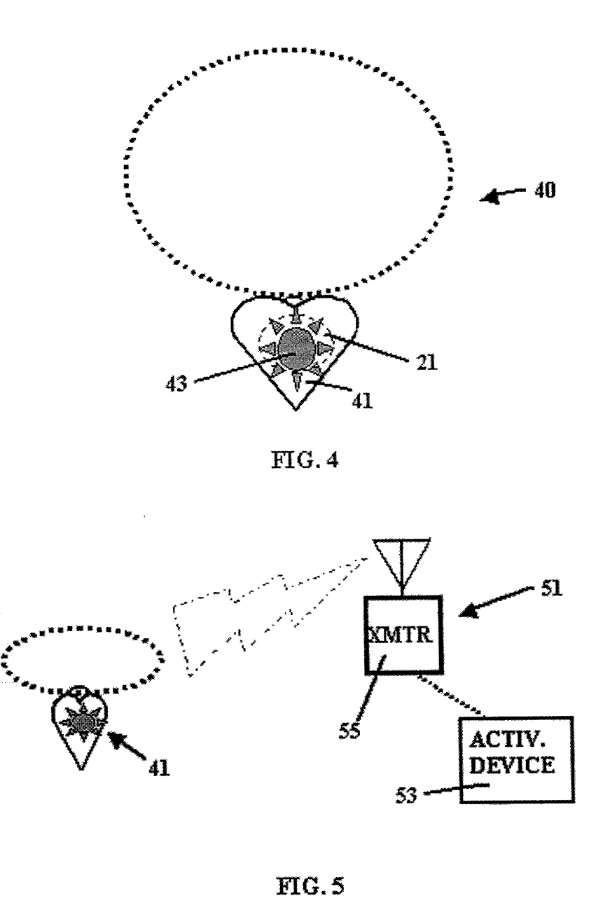

FIG. 4 shows a second wearable stimulation device in accordance with the invention. A pendent and chain 40 may be wearable on the neck of an individual, for example. Pendent 41 includes a receiver/stimulator 21 mounted therein. The receiver stimulator 21 enclosure may form the actual pendent and may include decorative aspects 43 or jewelry mounted thereon. Although a Pendent and chain is shown, it will be readily apparent that other wearable items may be utilized such as a locket or earring form in which a receiver/stimulator is suspended.

FIG. 5 illustrates a sensual massage system in accordance with the principles of the invention in which wearable stimulation devices such as a pendent 41, which is shown, or another stimulation device in accordance with the invention such as stimulation device 1 is worn by an individual. A radio frequency or other wireless system 51 is accessed by an activation device such as a personal communication type of activation device 53. Activation device 53 accesses a wireless transmitter 55 of system 51 which in turn is used to access and activate pendent 41. From activation device 53 a user may enter a code or phone number that uniquely identifies locket 41 or stimulation device 1. System 51 transmits a radio frequency signal that is received by locket 41 and wearable stimulation device 1. The radio frequency signal contains information that selectively actuates one or the other or both of the locket 41 and wearable stimulation device 1. The wearer or wearers of locket 41 and stimulation device 1 that is actuated receives a sensual vibration. Because the wearer would typically know who had access to the information that permits paging system to select the bracelet or stimulation device 1, a non-verbal message may be received.

The wearable stimulation devices, may in accordance with the principles of the invention, be operated to provide selectable vibration patterns such as a constant vibration for a present duration or other vibration patterns, such as a heartbeat simulating vibration effect or Morse code for example. The vibration patterns may be preset in the wearable stimulation device, or may be transmitted as information, like music or voice recording, along with the actuation signal. If it is transmitted with the actuation signal, microprocessor 35 included with receiver 31 recognizes the information and controls the signaling operation of vibrator 23. Obviously, to have voice recordings or sound emitted from the device 1, suitable electronics and speaker (not shown) would be included in the design, all of which are well within the easy capabilities of one skilled in the art.

In another embodiment of the invention, the radio frequency system comprises an individual transmitter in which the activation device 53 is integrated with the transmitter 51.

In other embodiments of the invention, the radio frequency system 51 comprises a commercially available paging system. The activation device is any one of the types of devices that are used with paging systems to page users. Activation device 53 may, for example, be a telephone, cellular phone or computer terminal. In addition, the communication between transmitter 55 and activation device 53 may be an Internet connection and activation device 53 may in such an instance be any number of devices that has access to the Internet, for example, or any means that allows for direct accessibility by a user to control operation of the wearable stimulation device.

The invention has been described in conjunction with several embodiments. It will be understood by those skilled in the art that various changes and modifications may be made without departing from the spirit or scope of the invention. Furthermore, it is not intended that the invention be limited in any way to the embodiments shown and described. It is intended that the invention be limited in scope only in accordance with the claims appended hereto.

What is claimed is:

1. A sensual massage system comprising:
a wireless controlled vibrator selectively operable via a wireless system and wearable by a user; and
a wireless system selectively operable to actuate said vibrator.

2. A sensual massage system in accordance with claim 1, wherein:
said wireless system comprises a radio frequency paging system; and
said wireless controlled vibrator comprise a pager receiver.

3. A sensual massage system in accordance with claim 1, wherein:
said wireless system is accessible via a telephone.

4. A sensual massage system in accordance with claim 1, wherein:
said wireless system is accessible via the Internet.

5. A sensual massage system in accordance with claim 1, wherein:
said vibrator is embeddable in a users clothing.

6. A sensual massage system in accordance with claim 5, wherein:
said vibrator is embedded in an enclosure.

7. A sensual massage system in accordance with claim 6, wherein:
said enclosure is flat and non-bulbous in shape and is adapted for retention proximate the clitoral region of a female wearer.

8. A sensual massage system in accordance with claim 1, wherein:
said vibrator comprises a pancake offset type vibrator.

9. A sensual massage system in accordance with claim 1, wherein:
said vibrator comprises a raised portion for stimulating the clitoral region of a user.

10. A sensual massage system in accordance with claim 1, wherein:
said wireless system generates radio frequency signals to actuate said vibrator.

11. A sensual massage system in accordance with claim 1, wherein:
said vibrator is operable to provide vibration patterns.

12. A sensual massage system in accordance with claim 11, wherein:
at least one of said patterns approximates a heartbeat.

13. A sensual massage system in accordance with claim 11, wherein:
said predetermined vibration patterns are determined in accordance with information provided via said wireless system.

14. A sensual massage system in accordance with claim 13 wherein:
said wireless system is accessible via the Internet.

15. A sensual massage system in accordance with claim 1, wherein:
said vibrator is carried by a jewelry item.

16. A vibrator comprising:
a vibrator motor;
a receiver for receiving wireless signals and selectively operating said vibrator motor; wearable carrier for containing said vibrator motor and said receiver whereby said vibrator motor and said receiver are wearable on the body of a person.

17. A vibrator in accordance with claim 16, wherein:
said wireless signals comprise radio frequency paging signals; and
said wireless controlled vibrator comprise a pager receiver.

18. A vibrator in accordance with claim 16, wherein:
said vibrator is embeddable in a users clothing.

19. A vibrator in accordance with claim 16, comprising:
an enclosure; and
said vibrator is embedded in said enclosure.

20. A vibrator in accordance with claim 19, wherein:
said enclosure is flat and non-bulbous in shape and is adapted for retention proximate the clitoral region of a female wearer.

21. A vibrator in accordance with claim 16, wherein:
said vibrator comprises a pancake offset type vibrator.

22. A vibrator in accordance with claim 16, wherein:
said vibrator comprises a raised portion for stimulating the clitoral region of a user.

23. A vibrator in accordance with claim 16, wherein:
said receiver receives radio frequency signals to actuate said vibrator.

24. A vibrator in accordance with claim 16, wherein:
said vibrator is operable to provide predetermined vibration patterns.

25. A vibrator in accordance with claim 24, wherein:
at least one of said patterns approximates a heartbeat.

26. A vibrator in accordance with claim 24, wherein:
said predetermined vibration patterns are determined in accordance with information provided via said wireless system.

27. A vibrator in accordance with claim 16, wherein:
said vibrator is carried by a jewelry item.
